(19) United States
(12) Patent Application Publication
(10) Pub. No.: US 2010/0274858 A1
(43) Pub. Date: Oct. 28, 2010

(54) MID-SERVICE SHARING

(75) Inventors: Phillip Lindberg, Helsingfors (FI); John Anthony Evans, Helsinki (FI); Johan Frossen, Helsinki (FI); Josephine Gianni, Helsinki (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/430,400

(22) Filed: Apr. 27, 2009

(51) Int. Cl. G06F 3/048; G06F 15/16

(52) U.S. Cl. 709/206; 715/835; 715/838

(57) ABSTRACT

An approach is provided for mid-service sharing and includes selecting an icon in a display on an apparatus. The icon represents an application, such as a network resource, in a particular state of interaction with the apparatus. Sending a message is initiated. The message specifies icon data for presenting the icon within a different user device. According to another embodiment, an approach includes receiving a message that specifies state data for a first user device to access a network resource in a state of interaction with a second user device. A media stream is transmitted to the first user device. The media stream is synchronized with a media stream being transmitted to the second user device. In some embodiments, once a collaborative session is evoked, the action of either user augments the state presented on other user's device, for the duration of the joint action.

### BACKGROUND

Content sharing applications have been one of the most widely used and popular applications over the Internet. At the same time, the use of wireless communication devices has become pervasive, and is rapidly overtaking the use of traditional wired devices. For example, one popular area involves the sharing of audio files and the generation and sharing of playlists among multiple mobile wireless devices. But even this amount of sharing does not give the degree of sharing that two or more friends would be able to achieve if in the same room. For example, friends in the same room can listen to the same music at the same time and comment on the current phrase or passage being played. Furthermore, when one runs an application on her mobile device and finds a remarkable result, such as a new restaurant in the vicinity, she can show that result to a friend who would be able to take the device and run the application from that point, for example to get the ratings or phone number of that restaurant. This kind of sharing involves sharing a network resource at a point of time between the beginning and the end of execution of a network service associated with the network resource, and is called herein mid-service sharing.

### SOME EXAMPLE EMBODIMENTS

It is determined that there is a need for mid-service sharing of an application, such as a network resource, among diverse user nodes on the network, no matter how far separated.

According to one embodiment, a computer-readable storage medium carries instructions which, when executed by a processor, cause an apparatus to at least perform selecting an icon in a display on the apparatus. The icon represents an application, such as a network resource, in a particular state of interaction with the apparatus. Sending a message is initiated. The message specifies icon data for presenting the icon within a different user device.

According to another embodiment, an apparatus comprises at least one processor and at least one memory including computer program code. The memory and the computer program code are configured to, with the processor, cause the apparatus to at least select an icon in a display on the apparatus. The icon represents an application, such as a network resource, in a particular state of interaction with the apparatus. The apparatus initiates sending a message that specifies icon data for presenting the icon within a different user device.

According to another embodiment, an apparatus includes a means for selecting an icon in a display on the apparatus. The icon represents an application, such as a network resource, in a particular state of interaction with the apparatus. The apparatus includes means for sending a message that specifies icon data for presenting the icon within a different user device.

According to another embodiment, a method includes providing access to receive a message that specifies state data for a first user device to access a network resource in a state of interaction with a second user device. A media stream is transmitted. The media stream is synchronized with a media stream being transmitted to the second user device.

According to another embodiment, a computer-readable storage medium carries instructions which, when executed by a processor, cause an apparatus to at least perform receiving a message that specifies state data for a first user device to access a network resource in a state of interaction with a second user device. Sending a media stream is initiated. The media stream is synchronized with a media stream being transmitted to the second user device.

According to yet another embodiment, an apparatus includes a means for receiving a message that specifies state data for a first user device to access a network resource in a state of interaction with a second user device. Means for sending a media stream is also included. The media stream is synchronized with a media stream being transmitted to the second user device.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings, in which:

FIG. 1A is a diagram of a system for mid-service sharing, according to one embodiment;

FIG. 1B is a diagram illustrating use of a mobile device of the system of FIG. 1A, according to one embodiment;

FIG. 2A is a diagram of components of a mid-service share module, according to one embodiment;

FIG. 2B is a diagram of a mid-service share message, according to one embodiment;

FIG. 3A is a diagram of components of an aggregated channel module, according to one embodiment;

FIG. 3B is a diagram of a back channel message, according to one embodiment;

FIG. 4A is a flowchart of a first process at a user device for mid-service sharing, according to one embodiment;

FIG. 4B is a flowchart of a second process at a user device for mid-service sharing, according to one embodiment;

FIG. 5 is a flowchart of a process at server to share streaming content simultaneously, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a terminal that can be used to implement an embodiment of the invention.

### DETAILED DESCRIPTION OF EXAMPLE EMBODIMENTS

A method, apparatus, and software are disclosed for mid-service sharing among separated user devices. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although several embodiments of the invention are discussed with respect to mid-service sharing of music streaming on different cellular telephones, embodiments of the invention are not limited to this context. It is explicitly anticipated that other content rendering applications and other local applications or network resources, such as World Wide Web sites, databases, navigation systems, rendering of other media, social networking, file transfer, email, instant messaging among others, are shared mid-service between two or more users of any node on a network, including any wired or wireless telephone, handheld device, computer, television set top box or other device.

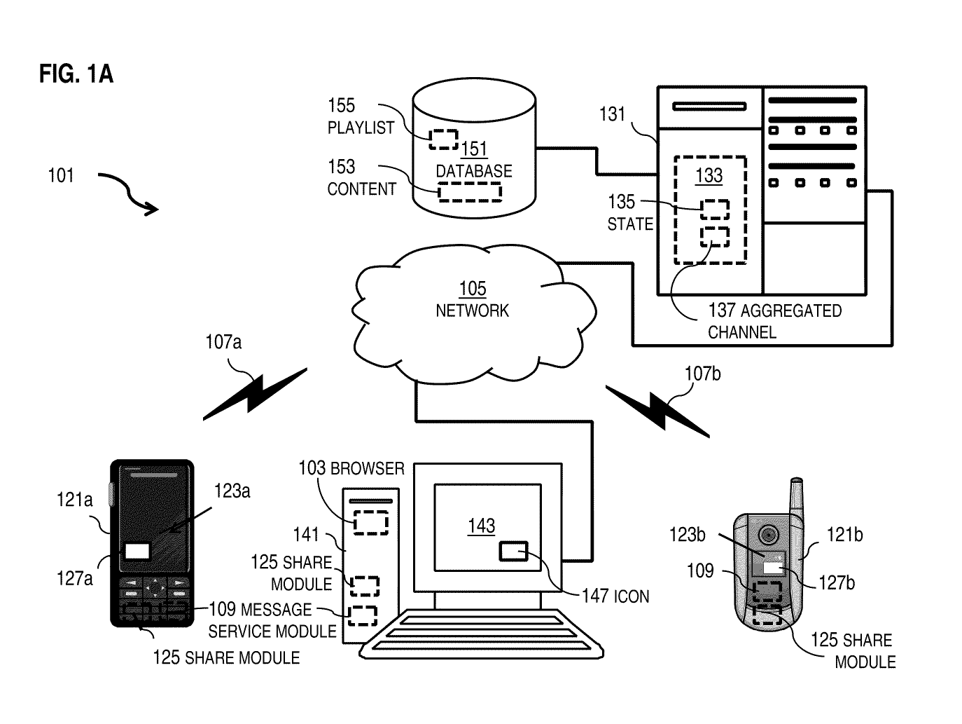

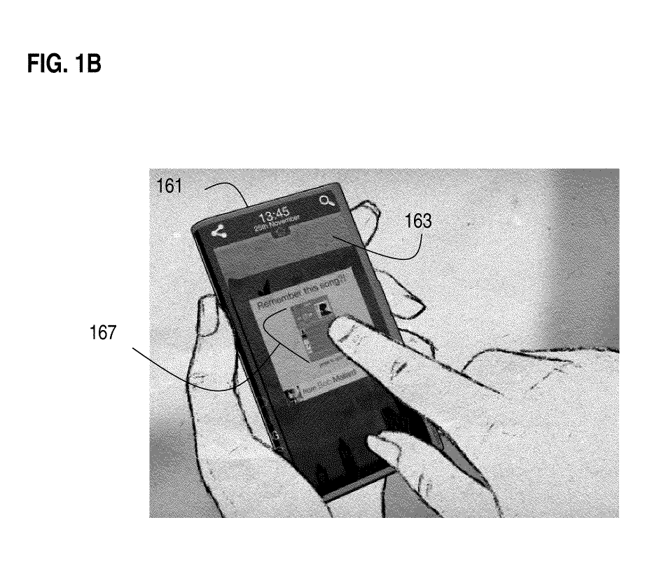

FIG. 1A is a diagram of a system 101 for mid-service sharing, according to one embodiment. The system 101 includes network 105 and network nodes 121a, 121b, 131 and 141. Node 131 is a host for a network resource accessed by the other nodes of network 105, including node 121a, node 121b and node 141.

In various embodiments, nodes 121a, 121b, 131 and 141 can be any type of fixed terminal, mobile terminal, or portable terminal including desktop computers, laptop computers, handsets, stations, units, devices, multimedia tablets, Internet nodes, communicators, Personal Digital Assistants (PDAs), mobile phones, mobile communication devices, audio/video players, digital cameras/camcorders, televisions, digital video recorders, game devices, positioning devices, or any combination thereof. Moreover, the nodes may have a hard-wired energy source (e.g., a plug-in power adapter), a limited energy source (e.g., a battery), or both. It is further contemplated that the nodes 121a, 121b, 131 and 141 can support any type of interface to the user (such as “wearable” circuitry, etc.). In the illustrated embodiment, nodes 121a and 121b are cellular telephone embodiments of wireless mobile terminals (each called a mobile station and described in more detail below with reference to FIG. 10). The cellular telephones 121a and 121b are connected to network 105 by wireless link 107a and wireless link 107b, respectively.

By way of example, the communication network 105 of system 100 can include one or more wired and/or wireless networks such as a data network (not shown), a wireless network (not shown), a telephony network (not shown), or any combination thereof, each comprised of zero or more nodes. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network, or any combination thereof. In addition, the wireless network may be, for example, a cellular network and may employ various technologies including code division multiple access (CDMA), wideband code division multiple access (WCDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, wireless fidelity (WiFi), satellite, and the like. In various embodiments, communication network 105, or portions thereof, can support communication using any protocol, for example, the Internet Protocol (IP).

Information is exchanged between network nodes of system 101 according to one or more of many protocols (including, e.g., known and standardized protocols). In this context, a protocol includes a set of rules defining how the nodes interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model. The OSI Reference Model is generally described in more detail in Section 1.1 of the reference book entitled “Interconnections Second Edition,” by Radia Perlman, published September 1999.

The client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. A well known client process available on most nodes connected to a communications network is a World Wide Web client (called a “web browser,” or simply “browser”) that interacts through messages formatted according to the hypertext transfer protocol (HTTP) with any of a large number of servers called World Wide Web servers that provide web pages. In the illustrated embodiment, node 141 includes browser 103 while mobile terminals 121a and 121b include browsers which are not shown to avoid obscuring other features of the embodiment. Similarly, node 131 includes a web server, not shown.

Node 131 is host to network resource 133 and is connected to a database 151 on computer-readable storage media. As is well known in the art, software processes running on a processor may be swapped into and out of memory as the processor is shared among multiple processes. When a process is swapped to memory, a record is kept of the software instruction at the time the process is swapped out and the current memory location and values of all variables and constants used by the process. This information represents the state of the process at the time of the swap and is stored on one or more computer readable storage media at the node 131. Similarly, when an application is paused, the state is stored. The state 135 of resource 133 is depicted in FIG. 1A.

In some embodiments, the network resource 133 is a content rendering server. In some such embodiments, the content to be rendered is stored on database 151 in content data structure 153. In the illustrated embodiment, the playlists of one or more users are also stored in database 151; for example, a collaborative playlist is stored in database 151 in playlist data structure 155.

Each user node includes a display for presenting data to a human observer, which includes screens or projectors for visual data and speakers or jacks for audio data. For example, node 121a includes display screen 123a, node 121b includes display screen 123b, and node 141 includes a display screen 143. Each visual display typically presents one or more icons, such as icon 127a on display screen 123a, icon 127b on display screen 123b, and icon 147 on display screen 143. As used herein, an icon is a complete or partial portion of a visual display, such as a portion associated with a local or client application or a network resource.

It is typical for user nodes 121a, 121b and 141 to include one or more message service modules, such as message service module 109, used to send messages to each other. Many message services are well known in the art, such as electronic mail (email) using the Post Office Protocol 3 (POP3), instant messaging (IM) services, text messaging between cellular telephones using the Short Message Service (SMS) protocol, and media sharing among cellular telephones using the multimedia messaging service (MMS). MMS is an extension of SMS, which allows longer message lengths and uses the Wireless Application Protocol (WAP) to display the content of the message.

According to some embodiments, one or more user nodes include a share module 125. In some embodiments, the share module 125 allows a user to capture an icon on a visual display and send it in a message to a node of another user by way of the message service module 109. It is not required that the other user also include a share module 125. In some embodiments, the message includes data that indicates an application and its state, such as the network resource 133 and its state 135, so that the user of the receiving node can access the application in the same state, i.e., mid-service. In some embodiments involving a network resource for rendering content, the mid-service access includes real time streaming of certain content to the remote user device synchronized with streaming of the certain content to the sending node, even if that requires starting the stream to the remote user device mid-content. In some of these embodiments, a user expression about the particular state of the application is transmitted to the other user in a different channel from the streaming content, e.g., using the message service module 109.

Although a particular set of nodes, processes, and data structures are shown in FIG. 1A for purposes of illustration, in various other embodiments more or fewer nodes, processes and data structures are involved. Furthermore, although processes and data structures are depicted as particular blocks in a particular arrangement for purposes of illustration, in other embodiments each process or data structure, or portions thereof, may be separated or combined or arranged in some other fashion.

FIG. 1B is a diagram illustrating use of a mobile device of the system of FIG. 1A, according to one embodiment. Mobile device 161, such as node 121a, includes a touch sensitive display screen 163 and icon 167. In the illustrated embodiment, the mobile node 161 is a receiving node and the icon 167 depicts a portion of the display screen of a sending node mid-service. By virtue of this pictorial cue, the user of mobile device 161 quickly understands what the user is invited to share before committing to activate the application. In the illustrated embodiment, the user touches the screen 163 near the center of the icon 167 to activate the application in the depicted state. Thus, messaging someone using an on-board messaging module gives that user direct shortcut access straight into a working application. In some embodiments, the message includes not only access to the application but all permissions to access a service, current state and content associated with the application, including hidden or personal material. This solution encourages discovery between peers and spreads usage of the shared application in a viral fashion.

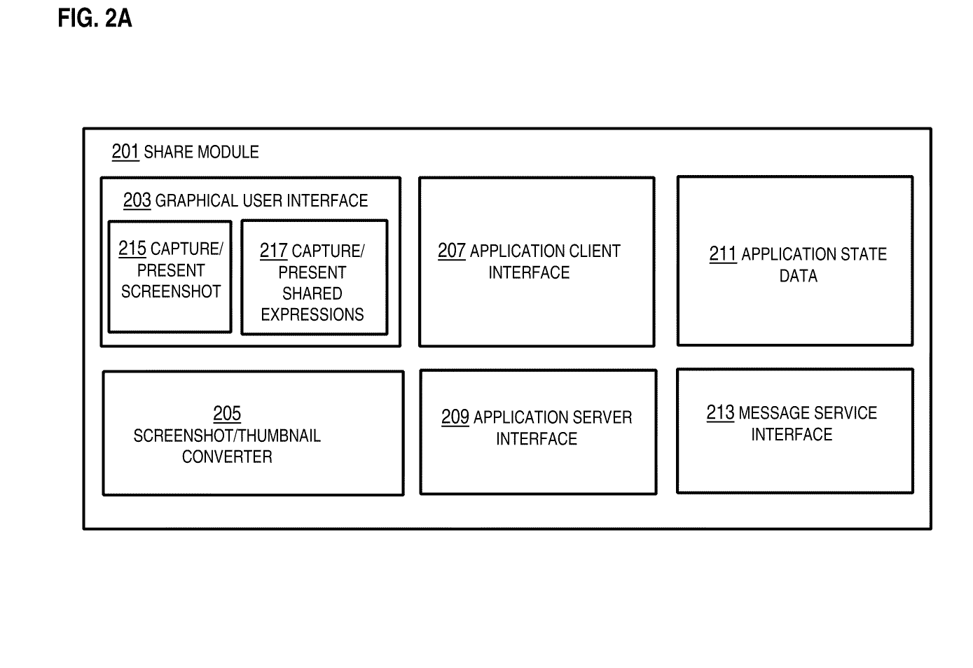

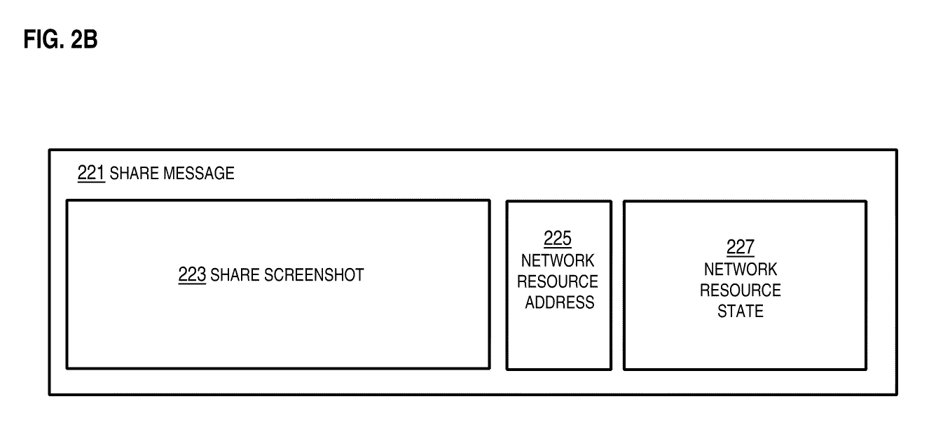

FIG. 2A is a diagram of components of a mid-service share module 201, according to one embodiment. The module 201 includes a graphical user interface 203, a screenshot/thumbnail converter 205, an application client interface 207, an application server interface 209, application state data 211, and messaging service interface 213.

The graphical user interface (GUI) module 203 is configured to provide the ability for the user to control the mid-service sharing. For example, in some embodiments, the GUI module presents a “SHARE APP” button that the user activates with a cursor or touch to indicate the time to capture an icon of the screen or other state information about the application. In some embodiments, the portion of the screen to capture as an icon is determined by user input in the form of one or more cursor positions or touch positions to surround an area of the display screen to include in an icon. In some embodiments, the GUI module 203 also presents the screenshot sent by another user. In the illustrated embodiment, the GUI module 203 includes a capture/present screenshot module 215 to capture and present screenshots.

In some embodiments, a network resource shared allows user expressions to be shared among multiple users, without requiring the local user to send messages separately to each user sharing the network resource. In such embodiments, the GUI module 203 includes a capture/present shared expressions module 217. This module 217 is configured to determine user touches or cursor movement to capture what letters or symbols or images are to be used in the expression. Similarly, module 217 is configured to present the letters and symbols and images received from the network resource and provided by other users. For example, in FIG. 1B the expression “Remember this song?!” is presented along with the icon of the network resource which includes presentation of metadata about the song, such as an identifier for the song being played and the performing artist.

In some embodiments, a physical button is used to indicate a time for mid-service sharing, the entire screen is captured as an icon, and physical keys are used to indicate an expression to send, so that a GUI module 203 is omitted.

The screenshot/thumbnail converter module 205 is configured to convert an icon that preserves the whole resolution of the captured screen to a smaller icon, called a thumbnail icon, which includes a smaller subset (e.g., 1/16) of the pixels in the full resolution icon. The pixels of the screenshot icon constitute a screenshot bitmap of a portion of the display. The thumbnail icon is a reduction of the screenshot bitmap. Often the context of the original icon is preserved in the thumbnail icon sufficiently for a user to decide whether the user has interest in the application and state being offered. In some embodiments, the thumbnail is sent to the remote user's device instead of the original icon to preserve bandwidth on the messaging channel or space on the local user's display screen. In some embodiments a thumbnail icon is sent in a first message, followed by the full icon in subsequent messages; and the module 205 is configured to replace the thumbnail icon by the full icon for display by the GUI module 203. In some embodiments, a thumbnail icon is not used and module 205 is omitted.

The application client interface module 207 is included in some embodiments, and configured to allow the share module to determine the current state for a client process, such as a browser, on the local device that communicates with the server process associated with the network resource. For example, in some embodiments, the module 207 is configured to determine the state data of the client process, including any credentials authorizing the user to access the content or services of the network resource, including credentials for a user of the different user device to access files owned by a user of the local device. In some embodiments the state of a browser includes the Web address to which the browser is communicating, such as a Uniform Resource Locator (URL) name, well known in the art, with any parameters, such as search terms submitted to a search engine. In some embodiments, the application client interface module 209 is further configured to use client state data received in a share message from a different user to cause the client process to assume that particular state on the local device.

The application server interface module 209 is included in some embodiments, and is configured to allow the share module to determine the current state for the network resource. For example, in some embodiments, the module 209 is configured to send a request message to the remote resource for a pointer to a data structure where the state is stored. The pointer is included in the state data sent to another user. In some embodiments, the module 207 is configured to send a request message to the remote resource for a complete record of the particular state; and the state data sent to another user includes this complete record. How to obtain this state data from a network resource is well known in the art, for example in a virtual pause option permitted for some network resources. In some embodiments, the state is fully described by the value of one or more parameters passed to the network resource, such as search terms for a search engine. In some embodiments, the application server interface module 209 is further configured to send state data received in a share message from a different user to the network resource to cause the network resource to assume that particular state. In some embodiments, the state of the client process is sufficient to reproduce the experience at the receiving user's device, and the application server interface module 209 is omitted.

The application state data 211 holds data that indicates the state of the application, such as the network resource and the client process at the time that the resource is to be shared with another user. In some embodiments, the state data structure 211 holds a pointer to a data structure of the network resource.

The message service interface module 213 is configured to include the screenshot or thumbnail icon in a message to another user, e.g., in a MMS message to a contact of the local user. In some embodiments, the message service interface module 213 is configured to send state data 211 instead of or in addition to the thumbnail or screenshot icon in the message. In addition, in some embodiments, the message service interface 213 is configured to pass expressions received from the network resource to the GUI interface for presentation with the thumbnail or screenshot icon to the local user; or to pass expressions entered by the local user to the network resource for dissemination to one or more other users.

FIG. 2B is a diagram of a service share message 221, according to one embodiment. The share message 221 includes a share screenshot field 223, a network resource address field 225 and a network resource state field 227. The share screenshot field 223 holds data that indicates the screenshot or thumbnail icon selected by the sender to show the context of the application on the sender's device. In some embodiments, the data in field 223 is simply a pointer to an image file on the network. In some embodiments, e.g., in some embodiments using an aggregated channel, the share screenshot field 223 is omitted.

The network resource address field 225 holds data that indicates the application, such as the network resource, with which the sender was interacting when the screenshot or thumbnail was captured. In some embodiments, the network resource address field 225 holds data that indicates a URL for the network resource. In some embodiments, the network resource address field 225 holds data that indicates an Internet Protocol (IP) address and Transmission Control Protocol (TCP) port number, both well known in the art, for the network resource.

The network resource state field 227 holds data that indicates the particular state of the interaction between the sending user device and the application, such as a pointer to a data structure with the network resource state. In some embodiments, the network resource state field 227 includes data that indicates the state of a client process on the sending user device, including any credentials authorizing access to the network resource or its content.

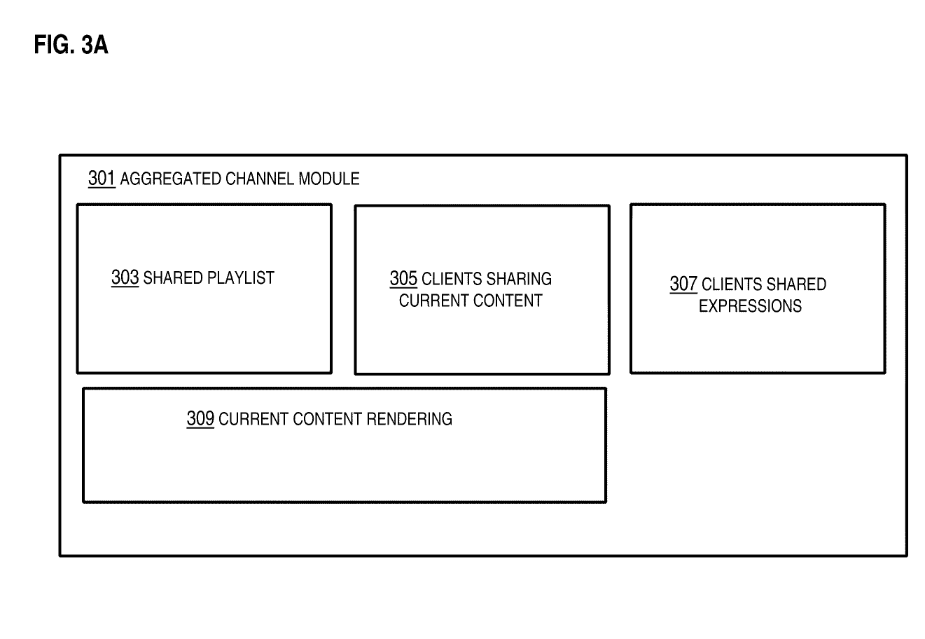

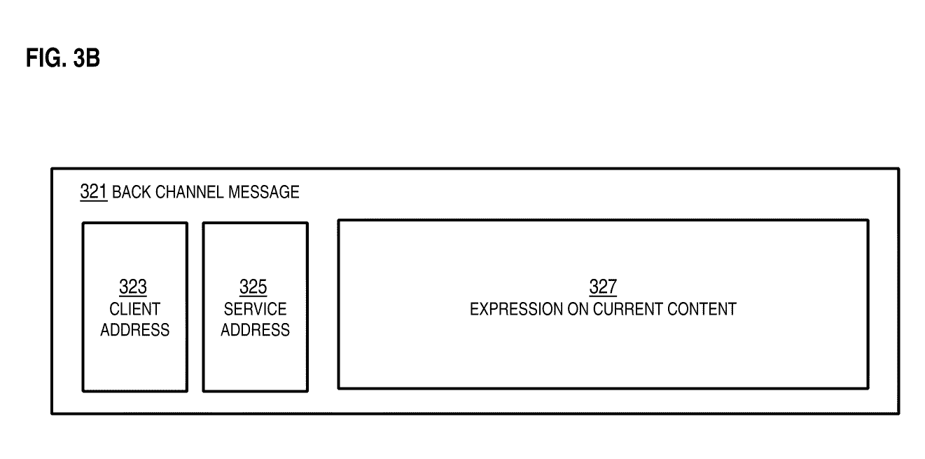

FIG. 3A is a diagram of components of an aggregated channel module 301, according to one embodiment. The aggregated channel module 301 is included at a network resource (e.g., module 137 in resource 133), and is configured to simultaneously stream content to multiple users that join the streaming service in response to a share message from a user. Since many of the invited users contact the streaming service mid-content, those users miss the first part of the content and receive the content at the current point of rendering for the inviting user.

In the illustrated embodiment, the aggregated channel module 301 includes a shared playlist module 303, a list of clients sharing current content data structure 305, clients shared expressions module 307 and a current content rendering module 309.

The shared playlist module 303, receives user edits for a shared playlist, e.g., in collaborative playlist data structure 155 in database 151, and updates the playlist, adding or deleting entries in the playlist data structure. In some embodiments, the edits to the collaborative playlist are received in messages sent by the message service module 109 on each user device. Collaborative playlists are known in the art, such as offered by SPOTIFY™.

The clients sharing current content data structure 305 stores data that indicate the network addresses of client processes for rendering content, which clients are rendering the same content simultaneously in real time. In some embodiments, the data structure 305 includes addresses for back channel messages, such as a network address for email, IM, SMS or MMS messages. The users of these clients have joined the group by virtue of accepting an invitation to share the content, e.g., sent in a share message 221.

The clients shared expressions module 307, accepts messages sent to the network resource from a client, e.g. in a back channel message, such as an SMS message that includes text or symbols or images, alone or in some combination. The module 307 then distributes that expression to all the other user devices, by using the back channel message addresses stored in data structure 305.

The current content rendering module 309, streams the current point of the current content in real time simultaneously to all client content rendering processes listed in the data structure 305. The content rendering module 309 is also configured to accept input from any user on the next content from the collaborative playlist to stream to all client content rendering processes listed in the data structure 305.

Although a particular set of modules and data structures are shown in FIG. 2A and FIG. 3A for purposes of illustration, in various other embodiments more or fewer modules and data structures are involved. Furthermore, although modules and data structures are depicted as particular blocks in a particular arrangement for purposes of illustration, in other embodiments each module or data structure or portions thereof, may be separated or combined or arranged in some other fashion.

FIG. 3B is a diagram of a back channel message 321, according to one embodiment. The back channel message 321 is sent in a different channel from the streaming content from the network resource. For example, in some embodiments, the back channel message 321 is sent as a SMS message. The illustrated back channel message 321 includes a client address field 323, a service address field 325 and an expression on current content field 327.

The client address field 323 holds data that indicate the network address of the message service module on the user device receiving the streaming content. In some embodiments, a multicast address is used in the client address field 323. Similarly, the service address field 323 holds data that indicate the network address of the message service module on the host 131 of the network resource 133. The expression on the current content field 327 holds text or symbols or graphics that express one user's reaction to the content when the message was sent from a user to the host of the network resource. Message 321 can be used to send expression from the client to the server and from the server to each client.

Although a particular set of data fields in a particular order in single messages are shown in FIG. 2B and FIG. 3B for purposes of illustration, in various other embodiments each message or data field, or portions thereof, may be separated or combined or arranged in a different order.

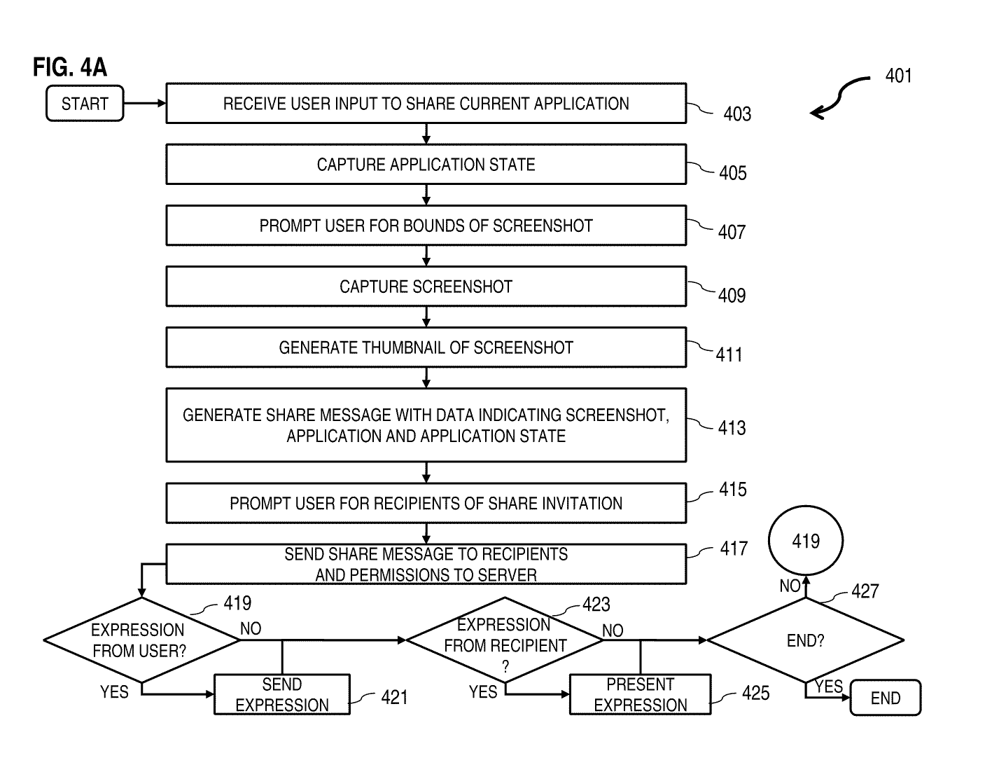

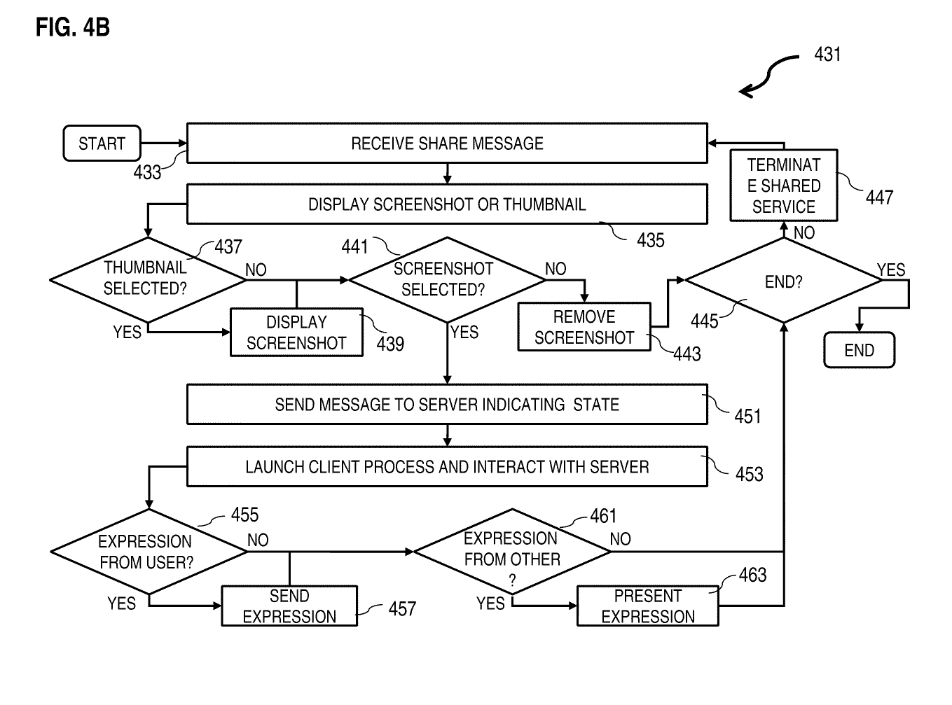

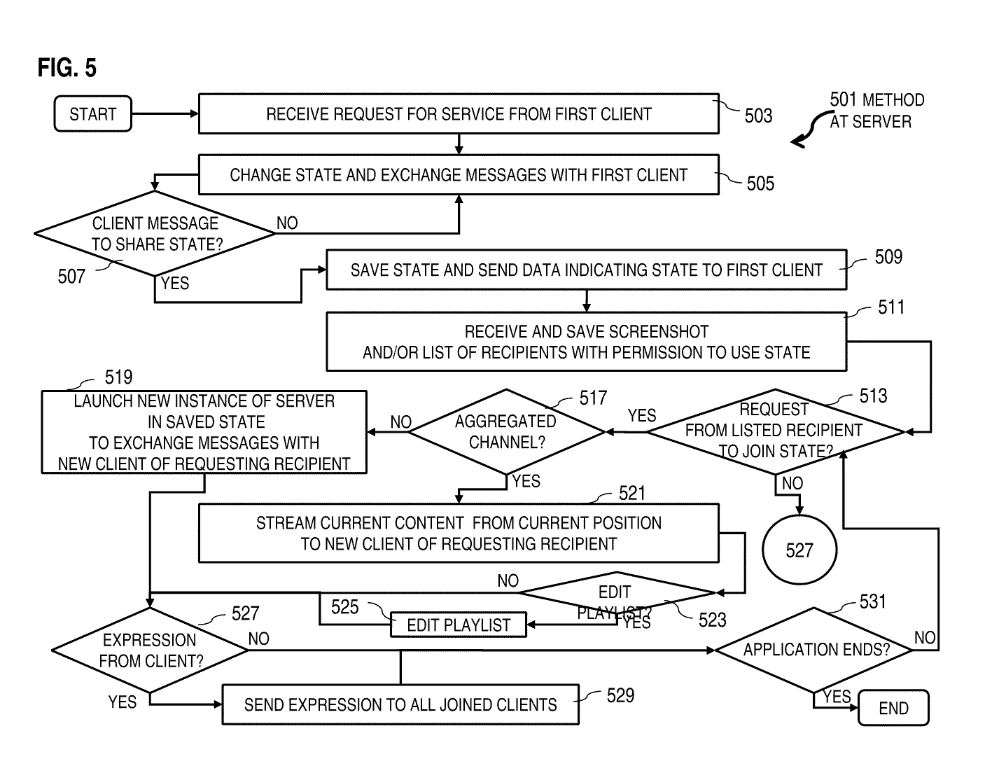

FIG. 4A is a flowchart of a first process 401 at a user device to share an ongoing service, according to one embodiment. Although steps in FIG. 4A and subsequent flow charts FIG. 4B and FIG. 5 are shown in a particular order for purposes of illustration, in other embodiments, one or more steps may be performed in a different order or overlapping in time, in series or in parallel, or one or more steps may be omitted or added, or changed in some combination of ways.

In step 403, user input is received that indicates a current application on the local device is to be shared with another device on the network. As used herein, an application refers to a standalone process running on a local device or a client process, such as a browser, running on the local device in communication with a server process associated with a network resource. The local device is a network node operated by a user. In some embodiments, the user input is received by detecting the activation of a physical button or switch on the local device. In some embodiments, the user input is received by detecting the user activating an active area of a graphical user interface on a display screen, such as by moving a pointing device to the active area or by touching the active area on a touch sensitive screen. For example, a user of cell phone node 121b is streaming a new song by a favorite band to cell phone 121b. Text indicting the song and band names and seconds into the play and a logo of the streaming service are depicted on his small screen in icon 127b.

In step 405, the application state is captured. Any method may be used to capture the application state. For example, in some embodiments, the application is a browser and the state is captured entirely by the URL of the server and the data following the URL in the HTTP request message, such as the search terms submitted to a search engine. In some embodiments, a client process on the local device sends a request for saving state to a server process associated with the network resource (called the resource server for convenience). In response to that request, the resource server saves the current state in a data structure available to the host for the server (e.g., host 131) and the server responds with a message indicating a pointer to the location of the current state in the data structure. The pointer is the state data indicating the particular state captured during step 405. For example, the URL of the streaming music server and the song identifier for the song and identifier for the user of cell phone node 121b are captured in step 405. For purposes of illustration, it is assumed that the URL is represented by URLX, the song identifier is SongY and the user identifier is UserB.

In step 407, a prompt is presented to the user to select an icon, e.g., by specifying the bounds of a screenshot to capture. For example, in one embodiment, the user touches an icon associated with the network resource and that icon becomes the screenshot icon. In another embodiment, the user circles a portion of the screen and the portion circled becomes the screenshot icon. This way, the user can focus on the portion of the screen that gives the proper impression and context to a user who receives the screenshot icon. In some embodiments, a default screenshot icon is selected, e.g., the entire screen or a smaller portion associated with the currently running application, and step 407 is omitted. For example, the user of cell phone node 121b indicates icon 127b.

In step 409 the screenshot icon is captured. For example, a pixel bitmap of the screenshot is selected as the screenshot icon. In some embodiments, such as some embodiments using an aggregated channel, a screenshot is not included and steps 407 and step 409 are both omitted. For example, the pixels of icon 127b on display screen 123b of cell phone node 121b are captured as screenshot icon during step 409.

In step 411, a thumbnail icon is generated from the screenshot icon, e.g., by selecting every fourth pixel in every fourth row of the screenshot icon. In some embodiments, the thumbnail is a grayscale combination of the red, green and blue pixels in the screenshot to further reduce the size of the thumbnail icon. For example, in some embodiments using SMS messages, the thumbnail is transmitted more easily than the screenshot. In some embodiments, the screenshot is transmitted and step 411 is omitted. For purposes of illustration, it is assumed that a thumbnail is not derived from the screenshot icon 127b.

In step 413, a share message, such as share message 221, is generated. The share message includes data that indicates the screenshot, the application and the application state. For example, in various embodiments, the screenshot icon or the thumbnail icon or a pointer to a screenshot icon saved at a network resource is included in share screenshot field 223 to indicate the screenshot icon. The URL of the network resource is stored in the network resource address 225. In some embodiments, the application is a standalone process on both the local and receiving user devices and the application is indicated by the application name, or the application might not be on the receiving user device and the application is indicted by a URL of a website where the application can be downloaded. In various embodiments, the application state captured during step 405 is indicated in field 227 by the actual state of both the local client and the resource server, or by a pointer to a data structure on the resource, and various credentials to gain access to the network resource or its content or hidden/private files, or by the data appended to a URL to cause the service to assume a certain state.

For purposes of illustration it is assumed that an MMS message is generated with the screenshot icon 127b in field 223, the URL of the streaming music server in field 225, and the text to be appended to the URL indicating the user identifier and the song identifier in field 227.

In step 415, a prompt is presented to the user to indicate other users, called recipients, of the share message. For example, in one embodiment, the user types the email address or telephone number of a contact, or selects a contact from the list of email or telephone contacts maintained by the local message service module. In some embodiments, the most recent contact is the default recipient, and step 415 can be omitted. For purposes of illustration, it is assumed that the user of cell phone node 121b indicates the cell phone number of the cell phone node 121a. Alternatively, or later, the user of cell phone node 121b may also create an email share message with the same information directed to the email address of a user of desktop computer node 141.

In step 417 the share message is sent to the recipients. In the illustrated embodiments, the credentials for accessing the resource server are included in the state data sent to the recipient. In some embodiments, the credentials or permissions are sent from the local user directly to the network resource server during step 417.

In step 419, it is determined whether the local user has entered an expression about the state of the application, such as content currently being rendered by a content streaming application. If so, then the expression is sent in step 421. In some embodiments, using an aggregated channel at the network resource server to stream content simultaneously to several users in corresponding streaming channels, the expression is sent during step 421 in a different channel (called a backchannel), e.g., in an email, SMS, MMS or HTTP message, to the network resource for distribution to the other recipients. In some embodiments without distribution by the resource server, the message is sent directly to one or more recipients in step 421.

In step 423, it is determined whether an expression about the state of the application, such as content currently being rendered by a content streaming application, is received from a recipient. If so, then the expression is presented on the display of the local device in step 425. In some embodiments, using an aggregated channel, the expression is received during step 423 in a back channel from the network. In some embodiments without distribution by the resource server, the message is received directly from one or more recipients in step 423. Thus, once a collaborative session is evoked, the action of either user augments the state presented on other user's device, for the duration of the joint action.

In step 427, it is determined whether the process is to end, if so, the process ends. Otherwise, steps 419 and following are executed again to send or receive additional messages about the current state of the application.

FIG. 4B is a flowchart of a second process 431 at a user device to share an ongoing service, according to one embodiment. In step 433, a share message, such as share message 221, is received by a recipient user. It is assumed for purposes of illustration, that the user of cell phone node 121a receives the SMS message sent by cell phone node 121b.

In step 435 the thumbnail icon or screenshot icon is displayed. In some embodiments, step 435 is performed by the GUI module 203 of the share module 201. In some of these embodiments, even though a screenshot icon is received, it is still converted to a thumbnail icon to reduce the impact of the display on whatever else the recipient user is viewing on the display screen of the recipient user's device. In some embodiments, the share message is displayed by the message service module 109, such as a MMS module. In such embodiments, the icon included in the share message is displayed. In some embodiments, the screen footprint of the recipient user device is very different from the screen footprint of the sending user device, and this difference affects the way that the screenshot icon appears. For example, in MMS it is a function of the WAP to determine how to display an image, such as the screenshot icon.

In step 437, it is determined whether a thumbnail icon is selected, e.g., by detecting that the user touched at or near the thumbnail icon, or detecting that the user activated a cursor positioned over or near the thumbnail icon. If so, then in step 439, the full screenshot icon is displayed. This allows the user to determine the full context of the application. By viewing the full screenshot, the user can tell that SongY is being streamed so many seconds into the song by the streaming service represented by the logo in the screenshot. For purposes of illustration, it is assumed that cell phone node 161 in FIG. 1B depicts cell phone node 121a when displaying a received MMS message in the MMS message viewer. The display screen 163 of cell phone node 161 shows the screenshot icon 167.

In step 441, it is determined whether the screenshot icon is selected by the recipient user, e.g., by detecting that the user touched at or near the screenshot icon, or detecting that the user activated a cursor positioned over or near the screenshot icon. If not, for example, if the user selects a “close screenshot” active area, then in step 443, the screenshot is removed from the display screen and it is determined if the process ends in step 445. If so, then the process ends. Otherwise in step 447 the most recently opened shared service is terminated and control passes back to step 433, described above, to receive the nest share message.

If it is determined, in step 441, that the screenshot icon is selected, as depicted in FIG. 1B by the recipient user touching the screenshot icon 167, then the service is activated in the particular state indicated in the share message. Any method may be used to activate the service. In the illustrated embodiment, a message is sent to the server indicating the state in step 451 and the client process is launched to interact with the server in step 453. In some embodiments in which the application is a standalone application, the standalone application is launched, such as by the application client interface module 207 in share module 201. During step 453, the recipient user interacts with the application, e.g., to edit the play list and stay involved in the next content rendered.

For purposes of illustration, it is assumed that the MMS viewer shows the screenshot with the song title and logo and the network resource server URL with data for the server, e.g., URLX/?SongY, UserB. It is further assumed that the URL includes the prefix www so that the recipient user's device recognizes a web server and automatically launches the local browser. The browser sends an HTTP request to the domain in the URL and includes the data SongY, and UserB, thus sending the state data to the server. In response, the server begins to stream the SongY. In an illustrated embodiment using an aggregated channel, the song SongY is streamed to the recipient's node (e.g., cell phone node 121a) in synchronization with the streaming to the sending node (e.g., cell phone node 121b), e.g., several seconds into the song.

In step 455 it is determined whether the recipient user has input an expression of reaction to the state of the application, e.g., the streaming song. If so, then that expression is sent in step 457. If the resource server supports it, the message is sent in step 457 to the resource server to distribute to all other users sharing the application, e.g., in a SMS back channel. If not, then the message is sent directly to whatever destination the recipient user indicated.

In step 461, it is determined whether another user has sent an expression of reaction to the state of the resource, e.g., the streaming song. If so, then that expression is presented in step 463. If the resource server supports it, the message is received in step 461 from the resource server in a back channel, e.g., in a SMS back channel. If not, then the message is received directly from another user. Thus, once a collaborative session is evoked, the action of either user augments the state presented on other user's device, for the duration of the joint action.

If it is determined in step 445, that the process ends, then in step 447 the shared service is terminated. For example, when no more songs are being streamed by the network resource, then streaming session is ended and the browser closes in step 447.

FIG. 5 is a flowchart of a process 501 at server to share streaming content simultaneously, according to one embodiment. In step 503, a request is received from a first client for service. For example, a request is received from userB to stream music to cell phone node 121b.

In step 505, messages are exchanged between the client and server and the state of the server and client processes change.

In step 507, it is determined whether the client indicates that the current state is to be shared with another user. If not, then further messages and state changes occur in step 505. If so, then in step 509 the server saves the current state and sends data indicating the current state, such as a pointer to a data structure where the current state is stored, to the first client. In some embodiments, where client side information is complete enough to reconstruct the state without this step, step 509 is omitted.

In step 511, the server receives from the first client data a screenshot icon or a list of recipients with permission to use the server in its current state. In some embodiments, in which the share message can handle the screenshot and all credentials to gain access to the server in its current state, step 511 is omitted.

In step 513 it is determined whether a request is received from a listed (or otherwise authorized) recipient to join the server in a particular state indicated in the request. For example a request for service includes data that indicates the particular state and all credentials to access the server in that state. If so, then in step 517 it is determined whether the service is for an aggregated channel. If not, then in step 519 a new instance of the server is launched in the indicated state (e.g., the saved state indicated in the request). The new instance then exchanges messages with a new client process for the authorized recipient and evolves its state separately for the authorized recipient, also during step 519.

If it is determined in step 517 that the requested service is for an aggregated channel, or if the server is configured only for an aggregated channel, then in step 521 the current content being streamed to the first client is also streamed to the new client of the authorized requesting recipient. In step 523, it is determined whether a message is received to edit a collaborative playlist (e.g., playlist 155 in database 151). If so, then in step 525 the collaborative playlist is edited.

In step 527, it is determined if an expression is received from one of the clients sharing the server. If so, then in step 529, the expression is distributed to all the other clients who have joined in sharing this service. Thus, once a collaborative session is invoked, the action of either user augments the state presented on other user's device, for the duration of the joint action.

In step 531, it is determined whether the application ends. If so, the server closes the present instance. Otherwise another request to join the service, if any, is detected in step 513. If no request is received form an authorized recipient to join a particular state of the service, then control passes again to step 527 to determine whether a user expression about the state of the service is received from one of the clients.

Using one or more of the methods described above, a user can share an application, such as a network resource, at any time during the execution of the application.

The processes described herein for mid-service sharing may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such example hardware for performing the described functions is detailed below.

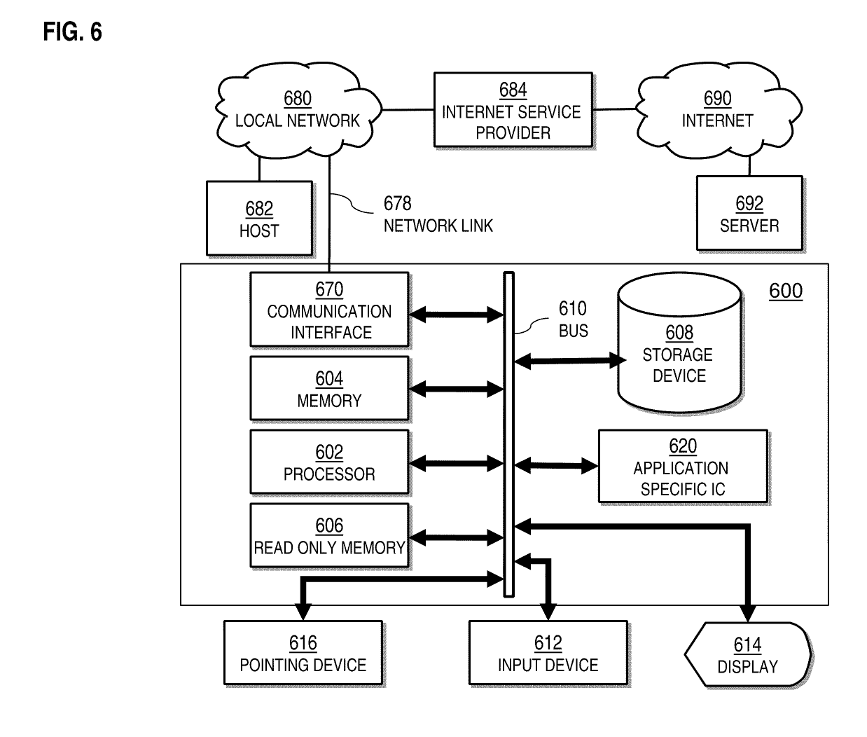

FIG. 6 illustrates a computer system 600 upon which an embodiment of the invention may be implemented. Computer system 600 includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 610 includes one or more parallel conductors of information so that information is transferred quickly among devices coupled to the bus 610. One or more processors 602 for processing information are coupled with the bus 610.

A processor 602 performs a set of operations on information. The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a transmission medium such as a cable or carrier wave, or any other medium from which a computer can read. Information read by a computer from computer-readable media are variations in physical expression of a measurable phenomenon on the computer readable medium. Computer-readable storage medium is a subset of computer-readable medium which excludes transmission media that carry transient man-made signals.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690. A computer called a server host 692 connected to the Internet hosts a process that provides a service in response to information received over the Internet. For example, server host 692 hosts a process that provides information representing video data for presentation at display 614.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

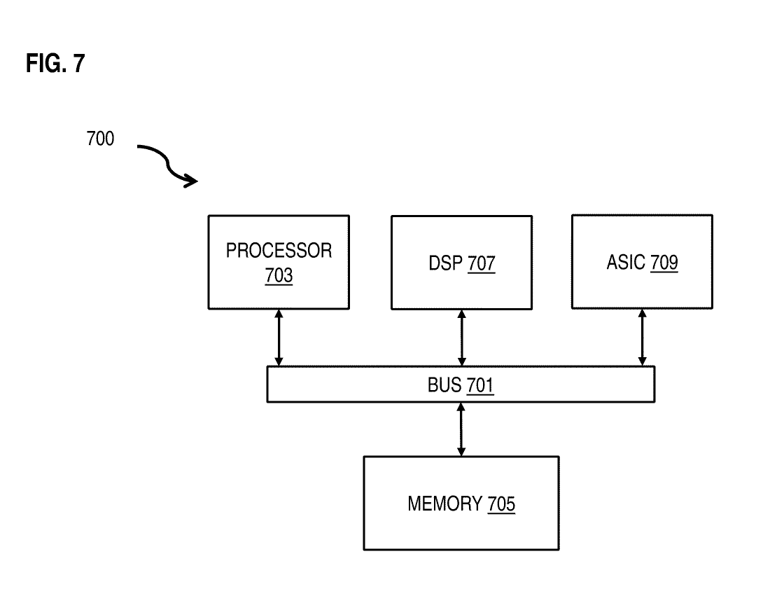

FIG. 7 illustrates a chip set 700 upon which an embodiment of the invention may be implemented. Chip set 700 is programmed to carry out the inventive functions described herein and includes, for instance, the processor and memory components described with respect to FIG. 7 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-word signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein. The memory 705 also stores the data associated with or generated by the execution of the inventive steps.

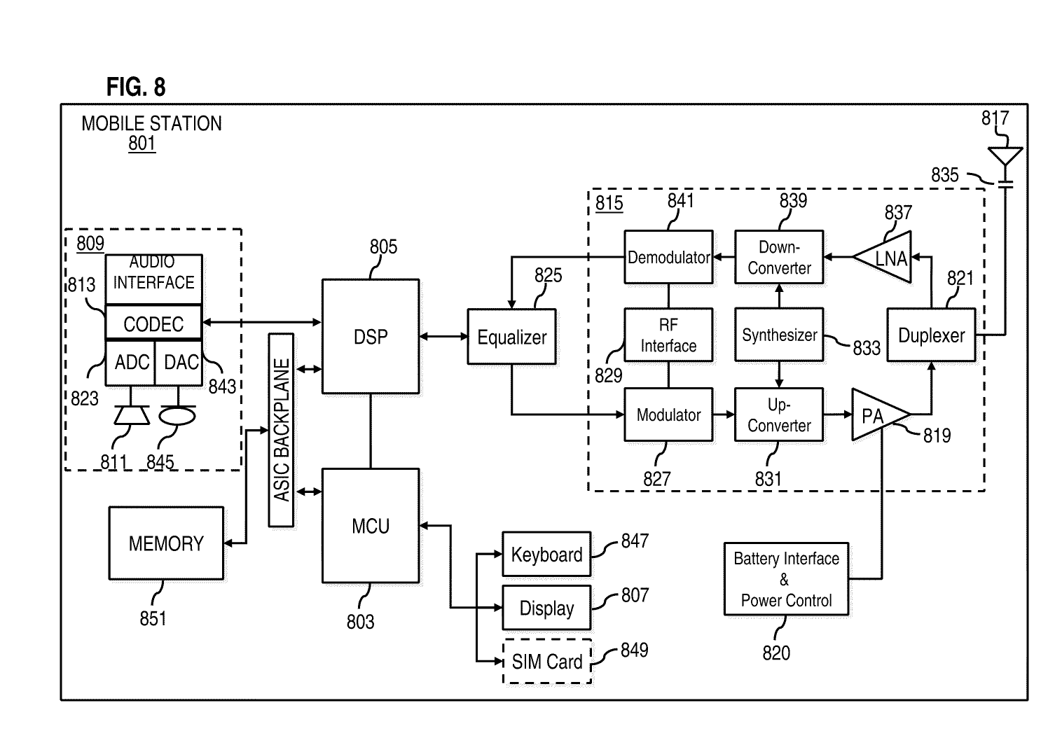

FIG. 8 is a diagram of example components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the station include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In the example embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The MCU 803 delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-readable storage medium carrying one or more sequences of one or more instructions which, when executed by one or more processors, cause an apparatus to perform at least the following:
selecting an icon in a display on the apparatus, wherein the icon represents an application in a particular state of interaction with the apparatus; and
initiating sending a message specifying icon data for presenting the icon within a different user device.

2. A computer-readable storage medium of claim 1, wherein the apparatus is caused to further perform determining state data that indicates the particular state of the application, wherein the message includes a network address for the application and the state data for accessing the application on the different user device in the particular state of interaction.

3. A computer-readable storage medium of claim 1, wherein selecting the icon in the display on the apparatus further comprises receiving user input that indicates a portion of the display on the apparatus to be shared.

4. A computer-readable storage medium of claim 1, wherein the apparatus is caused to further perform receiving user input that indicates the different user device to receive the message.

5. A computer-readable storage medium of claim 1, wherein the icon data is a pointer to a data structure in which is stored a screenshot of a portion of the display on the apparatus.

6. A computer-readable storage medium of claim 1, wherein the icon data is one of a screenshot bitmap of a portion of the display or a thumbnail reduction of the screenshot bitmap.

7. A computer-readable storage medium of claim 1, wherein the message sent to the different user device is one of a short messaging service (SMS) protocol message, an electronic mail (email) protocol message, a multimedia messaging service (MMS) protocol message, or a hypertext transport protocol (HTTP) message.

8. A computer-readable storage medium of claim 2, wherein determining state data further comprises determining a pointer to a data structure in which is stored the particular state of interaction with the apparatus.

9. A computer-readable storage medium of claim 2, wherein the application is a network resource for streaming media and the particular state of interaction is real time streaming of certain content to the different user device synchronized with streaming of the certain content to the apparatus.

10. A computer-readable storage medium of claim 2, wherein the state data includes credentials for a user of the different user device to access files owned by a user of the apparatus.

11. A computer-readable storage medium of claim 1, wherein the one or more processors are caused to further perform:
receiving user input that indicates an expression about the particular state of the application; and
initiating sending the expression to the different user device.

12. A computer-readable storage medium of claim 1, wherein the one or more processors are caused to further perform:
receiving from the different user device an expression about the particular state of the application; and
presenting the expression on the apparatus.

13. An apparatus comprising:
at least one processor; and
at least one memory including computer program code, the memory and the computer program code configured to, with the processor, cause the apparatus to perform at least the following:
selecting an icon in a display of the apparatus, wherein the icon represents an application in a particular state of interaction with the apparatus; and
initiate sending a message specifying icon data for presenting the icon within a different user device.

14. An apparatus of claim 13, wherein the processor and the memory are further configured to determine state data that indicates the particular state of the application, wherein the message includes a network address for the application and the state data for accessing the application on the different user device in the particular state of interaction.

15. A system including the apparatus of claim 13, the system further comprising the different user device configured to present the icon on a display of the different user device.

16. A system including the apparatus of claim 14, the system further comprising a host for the application configured to provide the state data in response to a request from the apparatus.

17. An apparatus of claim 13, wherein the message sent to the different user device is one of a short messaging service (SMS) protocol message, an electronic mail (email) protocol message, a multimedia messaging service (MMS) protocol message, or a hypertext transport protocol (HTTP) message.

18. An apparatus of claim 14, wherein determining state data further comprises determining a pointer to a data structure in which is stored the particular state of interaction with the apparatus.

19. A method comprising:
providing access to receive a message that specifies state data for a first user device to access a network resource in a state of interaction with a second user device; and,
transmitting a media stream synchronized with a media stream being transmitted to the second user device.

20. A computer-readable storage medium carrying one or more sequences of one or more instructions which, when executed by one or more processors, cause an apparatus to perform at least the following:
receiving a message that specifies state data for a first user device to access a network resource in a state of interaction with a second user device; and
initiating sending a media stream synchronized with a media stream being transmitted to the second user device.
